(19) United States
(12) Patent Application Publication
(10) Pub. No.: US 2011/0185408 A1
(43) Pub. Date: Jul. 28, 2011

(54) SECURITY BASED ON NETWORK ENVIRONMENT

(75) Inventor: Steven L. Travis, Loveland, CO (US)

(73) Assignee: Hewlett-Packard Development Company, L.P., Houston, TX (US)

(21) Appl. No.: 13/080,199

(22) Filed: Apr. 5, 2011

Related U.S. Application Data
(63) Continuation of application No. 11/742,265, filed on Apr. 30, 2007.

(51) Int. Cl. G06F 7/04; G06F 12/14

(52) U.S. Cl. 726/6; 726/23

(57) ABSTRACT

A method comprises assessing a network environment in which an electronic device is present and implementing a security feature based on the assessment of the network environment. Assessing the network environment comprises identifying other network entities on a network to which the electronic device is coupled.

### BACKGROUND

Security of computing devices, such as servers, network attached storage (NAS) devices, etc., is of concern to most, if not all, organizations. Such devices can be stolen and thus the information stored therein may fall into unauthorized hands. Even if the stolen device does not itself have any confidential information of the organization, the device can be used to access the organization's network.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows an example of the use of the system of FIG. 1;

FIG. 3 shows another example of the use of the system of FIG. 1; and

FIG. 4 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to the combination of two or more components and includes a complete operative system and subsystems thereof.

### DETAILED DESCRIPTION

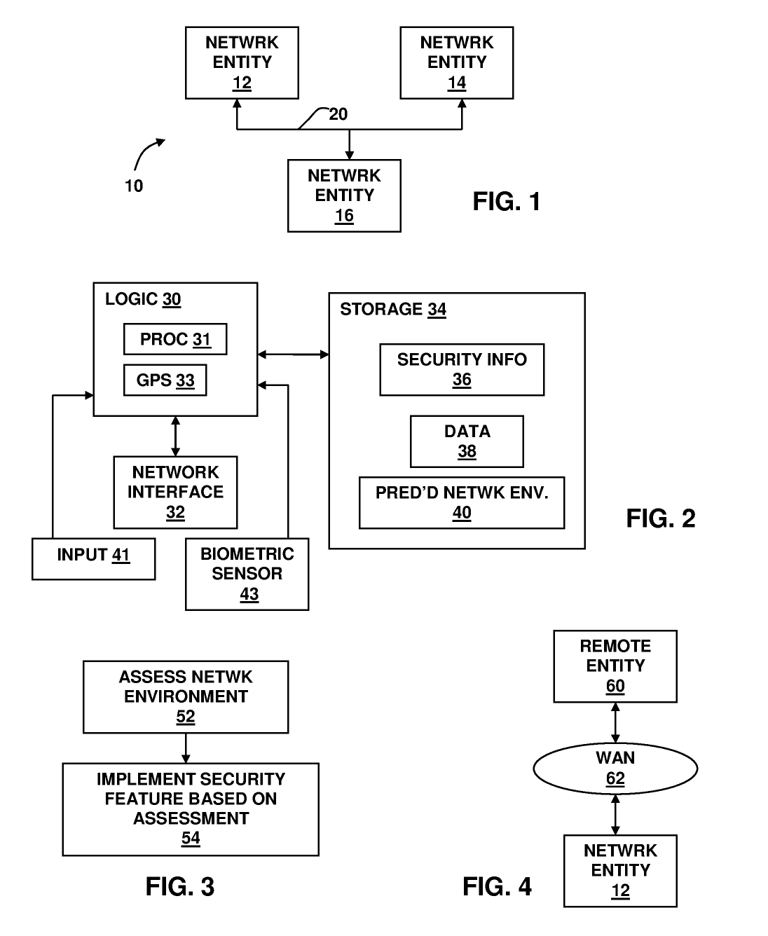

FIG. 1 illustrates a system 10 in accordance with various embodiments. The system 10 comprises one or more devices 12, 14, and 16 communicatively coupled together via a network link 20 to form, for example, a local area network (LAN). Each device 12, 14, 16 may comprise any type of networked entity such as a network-attached storage (NAS) device, a computer, a router, a printer, etc.

Each network device 12, 15, 16 comprises an identity by which other devices access the device over the network. In at least one embodiment, an identity comprises an address (e.g., medium access control (MAC) address, internet protocol (IP) address, etc.).

FIG. 2 illustrates an embodiment of any of the network devices 12, 14, 16. Each device comprises logic 30 coupled to a network interface 32 and to storage 34. In at least some embodiments, the logic 30 comprises a processor 31 that executes code. The logic 30 also comprises a location-determining device such as global positioning system (GPS) receiver 33. The GPS receiver determines the physical location of device 12, 14, 16 (e.g., longitude/latitude).

The network interface 32 comprises a network interface controller (NIC) or other suitable network interface that enables the device 12, 14, 16 to receive communications from, and send communications to, other devices on the network 20.

The storage 34 comprises volatile memory (e.g., random access memory), non-volatile storage (e.g., hard disk drive, read-only memory, Flash memory, etc.), or combinations of volatile memory and non-volatile storage. The storage 34 stores security feature information 36, data 38, and security feature information 40. In some embodiments, the device 12, 14, 16 comprises a NAS device and thus data 38 comprises data stored on the NAS device and accessible by other devices on the network 20.

At least one of the devices 12, 14, 16 is capable of implementing one or more security features, in some embodiments referred to as “security policies.” In some embodiments, a security policy is defined by one or more security features. Information specifying the security features is stored in storage 34 as security information 36. In some embodiments, the security features comprise security levels. To the extent multiple security levels are implemented, a first security level may be higher than a second security level. More than two security levels can be implemented in a device 12, 14, 16 as desired. The security features comprise such features as passwords, biometric authentication (e.g., fingerprint, retinal scan), questions such as name of pet, elementary school name, shoe size, mother's maiden name, etc. A higher security level might require, for example, entry of a particular password and biometric authentication of the user, while a lower security level might require only biometric authentication or no user authentication at all.

A device 12, 14, 16 may comprise an input device 41, such as a keyboard, by which a password can be entered by a user and/or biometric sensor 43, such as a fingerprint or retinal scanner, by which the user can personally/physically authenticated. In some embodiments, the input device and/or biometric sensor are provided on the device 12, 14, 16 for which the password and/or biometric data is to be used for authentication. In other embodiments, the keyboard and biometric sensor provided on one device 12, 14, 16 are used to enter authentication information (e.g., password, biometric sensor data) to be used to authenticate a user for access to a different device 12, 14, 16.

In accordance with embodiments of the invention, at least one of the devices 12, 14, 16 operates according to the method illustrated in FIG. 3. In FIG. 3, the illustrative method comprises actions 52 and 54. At 52, the method comprises the device 12, 14, 16 assesses its network environment and, at 54, implements a security feature based on the assessment of the network environment.

In at least one embodiment, the term “network environment” refers to the configuration of the local area network in which the device is operating. For example, the network environment for a given device 12, 14, 16 is defined by the identity of the other devices 12, 14, 16 coupled to the given device. The device assessing its network environment identifies the other network entities (e.g., devices 12, 14, 16) to which the device is coupled. The device assessing its network environment may, for example, broadcast a message on the network link 20 for any and all devices coupled thereto to reply with their identifier (e.g., network address or other network asset names such as “\\SuperNAS”). The collection of addresses thus received comprises an example of the network environment for a given device.

In at least one other embodiment, the term “network environment” refers to the physical location of the device assessing its network environment. Per FIG. 2, a device 12, 14, 16 comprises a GPS receiver 33 that can determine the physical location of the device.

In some embodiments, a device's network environment comprises either or both of the above-described examples. For example, a device 12, 14, 16 may assess its network environment by determining the identities (e.g., addresses) of other devices on the same LAN, as well as determining the device's physical location. That is, both pieces of information, in some embodiments, may comprise the device's network environment.

A given device 12, 14, 16 comprises a predetermined network environment. That is, once a device 12, 14, 16 is installed and operating on a given LAN, the other network entities to which that device couples over the network as well as that device's physical location is known, and thus the device's network environment is known. Data defining the device's predetermined network environment 40 is stored in storage 34. Such data comprises, for example, the identifiers of other network entities on the same LAN, the physical location, etc.

Implementing the security level (54) in FIG. 3 comprises, in some embodiments, comparing the network environment from the assessment action (52) to the device's predetermined network environment. If the network environments match, then a first security feature, or set of features, is implemented. If the network environments do not match, then a second security feature, or set of features is implemented.

For example, if the predetermined network environment specifies that the device's physical location is at a first location (e.g., the user's office, a specific geographical coordinate or range of coordinates, or name of workgroup) and the device's current location, determined during the assessment action 52 is the same, then the device 12, 14, 16 may be considered to be in a “safe” location and less security features can be implemented, or no security features. However, if the device is determined not to be in a location commensurate with the predetermined network environment, then the device may be determined to be in an “unsafe” location (e.g., the device may have been stolen) and a heightened security feature is implemented (e.g., password enabled, biometric scan required, etc.).

In some embodiments, a device 12, 14, 16 periodically (e.g., once per minute, hour, day, etc.) performs the method of FIG. 3 to reassess its network environment and adjust its security features accordingly. In other embodiments, an entity external to the device prompts the device to perform the method of FIG. 3.

If a user has forgotten his or her password, such as an administrative password usable to change the configuration of the device 12, 14, 16, the device may automatically disable its password security feature if the device, per for example the method of FIG. 3, determines that is in a safe network environment (e.g., safe location). If the device determines that is not in a safe network environment, the password security feature is enabled and, if desired, additional security features are implemented.

In some embodiments, the device 12, 14, 16 performs the method of FIG. 3. In other embodiments, a remote entity interacts with the device 12, 14, 16 to perform the method of FIG. 3. FIG. 4 illustrates a remote entity 60 (e.g., a server computer) that is communicatively coupled to a device 12 (or devices 14 or 16 for that matter) via a wide area network (WAN). The remote entity 60 may or may not be part of the network environment of device 12. If a user of the device 12 forgets his or password, the user contacts (e.g., by the Internet or a phone) an organization that operates the remote entity 60. The remote entity 60 submits a request message to device 12 via WAN 62 to cause the device 12 to perform an assessment of its network environment. The device 12 performs the assessment as explained above, and reports a description of its network environment back to the remote entity 60 via WAN 62. The predetermined network environment for the device 12 is stored on, or otherwise accessible to the, remote entity 60. The remote entity 60 compares the reported network environment to its previously stored network environment to determine whether there is a match. The remote entity 60 sends a command to the device 12 to implement a security feature based on whether the remote entity 60 determined the network environments to match. In various embodiments, the remote entity 60 causes a higher security feature or level to be implemented if the network environments do not match than if the network environments do match.

Whether the device's current network environment and the predetermined network environment match does not necessarily mean that all characteristics defining the network environment need match exactly. For example, at least one or more of the network environment's characteristics must match for the network environments to be considered as matching. For example, if the one or more of the identities of the network entities to which the device is coupled comport with identities provided in the predetermined network environment, then the network environments match even if all of the network environments do not match. The logic that dictates whether the current and predetermined network environments match can be preset or configured by a user. For example, a user can specify the number of characteristics that define a network environment or the type of such characteristics that must match for the network environments to be considered a match.

In accordance with various embodiments, if a device 12, 14, 16 determines that is “under attack” (e.g., being accessed by an unauthorized entity, a virus has been detected, etc.), the device under attack transmits a message to the other devices on the network indicating the detection of the attack. The devices receiving the attack message use this information when implementing their own security features. For example, a device receiving the attack message may implement a heightened security feature (enable a password when a password was not previously required, require biometric user verification, etc.).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
detecting, by a first computer, an attack;
broadcasting, by said first computer, a message to a plurality of other computers, said message indicating the first computer is under attack; and
said plurality of other computers responding to said message by implementing a heightened security feature.

2. The method of claim 1 wherein the heightened security feature comprises enabling a password.

3. The method of claim 1 wherein the heightened security feature comprises requiring biometric user verification.

4. A method, comprising:
receiving, by a first computer, an attack message from another computer, said attack message indicating that the other computer is under attack; and
as a result of receiving said attack message, implementing, by the first computer, a heightened security feature.

5. The method of claim 4 wherein the heightened security feature comprises enabling a password.

6. The method of claim 4 wherein the heightened security feature comprises requiring biometric user verification.

7. A system, comprising:
a plurality of computers networked together;
each of said computers configured to:
detect an attack and broadcast an attack message to all other of said computers that an attack has been detected; and
receive an attack message from another computer of said plurality of computers and respond to said received attack message by implementing a heightened security feature.

8. The system of claim 7 wherein the heightened security feature comprises enabling a password.

9. The system of claim 7 wherein the heightened security feature comprises requiring biometric user verification.
